(19) United States
(12) Patent Application Publication
(10) Pub. No.: US 2026/0229937 A1
(43) Pub. Date: Aug. 6, 2026

(54) ROTOR FOR A SEPARATELY EXCITED ELECTRIC MACHINE, SEPARATELY EXCITED ELECTRIC MACHINE, MOTOR VEHICLE AND MANUFACTURING METHOD FOR MANUFACTURING A ROTOR FOR A SEPARATELY EXCITED ELECTRIC MACHINE

(71) Applicant: AUDI AG, Ingolstadt (DE)

(72) Inventors: Philipp UHLMANN, Ingolstadt (DE); Korbinian WEBER, Ingolstadt (DE)

(21) Appl. No.: 19/462,813

(22) Filed: Jan. 28, 2026

(30) Foreign Application Priority Data
Jan. 29, 2025 (DE) 102025103126.6

(51) Int. Cl. H02K 1/26; H02K 3/28; H02K 7/04; H02K 11/33; H02K 15/026; H02K 15/062

(52) U.S. Cl. CPC H02K 1/26; H02K 3/28; H02K 7/04; H02K 11/33; H02K 15/026; H02K 15/062; H02K 2203/03; H02K 2211/03

(57) ABSTRACT

Rotor for a separately excited electric machine, having a plurality of coils for generating a rotor magnetic field, wherein each coil has two wire ends via which the respective coil is electrically contacted, wherein the rotor comprises a printed circuit board which has a first through-hole and a plurality of second through-holes, wherein the first through-hole of the printed circuit board is penetrated by a rotor shaft extending along an axis of rotation of the rotor, wherein the wire ends of the coils are each guided through one of the second through-holes of the printed circuit board, so that at least one section of the respective wire end emerges from a side of the printed circuit board facing away from the coils, wherein the wire ends of the respective coil are connected to separate conductive sections of the printed circuit board.

### BACKGROUND

### Technical Field

The disclosure relates to a rotor for a separately excited electric machine having a plurality of coils for generating a rotor magnetic field, wherein each coil has two wire ends via which the respective coil is electrically contacted. Furthermore, the disclosure relates to a separately excited electric machine, a motor vehicle as well as a manufacturing method for manufacturing a rotor for a separately excited electric machine.

### Description of the Related Art

Separately excited electric machines comprise a rotor with at least one rotor winding or coil for generating a rotor field. The rotor can have a plurality of individual coils that are connected together in series, for example, in particular to form a plurality of rotor poles. To achieve this, the poles can be wound with a continuous wire. However, conventional interconnection by continuously winding the poles has a plurality of disadvantages. Thus, at the end of the winding of a pole, a chord must be stretched over the already laid winding. This chord interferes with the impregnation of the rotor and is demanding in terms of strength. In addition, this results in a crossing of wires between which there can be a large number of windings and thus a high potential difference, which requires complex electrical insulation.

The publication US 2014/ 0 300 226 A1 discloses a synchronous machine comprising a stator consisting of a plurality of separately manufactured coil modules.

### BRIEF SUMMARY

The disclosure is based on the task of providing a rotor with a plurality of coils which avoids the aforementioned disadvantages of continuous winding of the poles with low manufacturing costs.

To solve this task, in a rotor of the type mentioned at the beginning, it is provided according to the disclosure that the rotor comprises a printed circuit board which has a first and a plurality of second through-holes, wherein the first through-hole of the printed circuit board is penetrated by a rotor shaft extending along an axis of rotation of the rotor. The wire ends of the coils are each guided through one of the second through-holes of the printed circuit board, so that at least one section of the respective wire end emerges from a side of the printed circuit board facing away from the coils, wherein the wire ends of the respective coil are connected to separate conductive sections of the printed circuit board. In particular, the rotor can be a rotor for a separately excited synchronous machine.

The printed circuit board may be advantageously designed as a disk and can be placed on the rotor shaft by way of the first through-hole during the manufacture of the rotor, so that the printed circuit board can span an axial end of the coils. The respective wire ends of the coils, which can project beyond the windings of the respective coils at an axial end of the coils at least substantially parallel, i.e., in particular at an angle of less than 10° or 5°, to an axis of rotation of the rotor, are guided through the second through-holes. The diameters of the first through-hole and the second through-holes are conveniently dimensioned in such a way that the printed circuit board can be easily placed on the rotor shaft and the respective wire ends during manufacture without having too much play. Furthermore, the printed circuit board may be advantageously at least essentially perpendicular to the axis of rotation in the mounted state, i.e., in particular at an angle of at least 60° or at least 80°.

Conveniently, the printed circuit board has n second through-holes, wherein n is equal to the number of wire ends protruding from the coils. In particular, the number of wire ends is twice as large as the number of coils installed in the rotor. Furthermore, the second through-holes on the printed circuit board may be advantageously arranged to be rotationally symmetrical, in particular if the arrangement of the coils is also rotationally symmetrical. This can facilitate the handling of the printed circuit board during the manufacture of the rotor.

In the rotor according to the disclosure, all wire ends are arranged at least in sections on the side of the printed circuit board facing away from the coils. On this side, the wire ends of the respective coil are connected to the conductive sections of the printed circuit board. In the context of this document, the conductive sections are also referred to as conductor tracks, irrespective of their form. The conductor tracks of the printed circuit board can, for example, connect all or a plurality of the wire ends to sliding contacts or a rectifier output.

In contrast to a conventional interconnection, which is created by winding through the entire rotor, the rotor according to the disclosure eliminates the need to guide a chord over the already laid winding, thus avoiding crossing points in the winding. This simplifies the manufacture of the rotor, particularly with regard to the required insulation of the windings and the impregnation.

In particular, the respective conductive section of the printed circuit board is directly adjacent to one or more of the second through-holes and/or makes contact with a contact element passing through the respective second through-hole. The respective conductive section can be designed in particular as an elongated conductor track or as a conductive surface, wherein the conductor track or the conductive surface connects at least two of the second through-holes.

The diameter of the respective second through-hole advantageously may be only slightly larger than the diameter of the respective wire end guided through it, for example less than 5 mm or less than 2 mm or less than 1 mm larger. Thus, after guiding the respective wire end through the respective second through-hole, at most a small gap remains between the respective wire end and the respective conductive section, which can be bridged conductively as part of the connection, for example by solder in the case of connection by soldering, without the wire end having to be deformed.

In an advantageous further development of the disclosure, at least one of the conductive sections of the printed circuit board can conductively connect one of the wire ends of a first of the coils to one of the wire ends of a second of the coils, so that the first and second coils are connected in series or parallel to each other by way of the printed circuit board.

In particular, all coils can be connected in series or parallel to each other through the conductive sections. Alternatively, it can also be possible to form a combined circuit in which, for example, a first part of the coils is connected in series and a second part of the coils is connected in parallel. The use of the printed circuit board for contacting the individual coils therefore offers the advantage that the desired interconnection of the individual coils can be produced quickly and easily during the manufacture of the rotor.

Advantageously, the printed circuit board can be at least substantially circular and/or cover at least half, in particular the entirety, of the coils in a radial direction with respect to the rotor shaft.

Thus, the printed circuit board can be placed on the axial end of a coil-carrying section of the rotor, whereby the coils can be covered to different extents depending on the size, in particular the diameter, of the circular printed circuit board, so that the coils are at least partially covered by the printed circuit board when looking at the axial end of the rotor in the finished assembly state and are not visible.

The distance of the radially outer edge of the printed circuit board from the axis of rotation of the rotor can advantageously vary by a maximum of 10% or a maximum of 5% of the maximum of this distance, so that at least essentially a circular shape results. This prevents imbalance and achieves low air resistance during rotation.

Covering at least half of the coils in the radial direction can be understood to mean in particular that the printed circuit board covers at least half of the coil surface of the respective entire coil. Advantageously, the printed circuit board can completely cover the coils. In general, it is desirable that the coils are covered as much as possible by the printed circuit board, as this means that the wire does not have to be stretched over the respective winding of the coil in order to be fed through the respective second through-hole of the printed circuit board, for example, even if the two wire ends of the respective coil are arranged on radii that are significantly different from each other. If the coils are extensively covered by the printed circuit board, i.e., in particular if at least half of the coils are covered, air friction losses during the rotation of the rotor can also be significantly reduced in an advantageous manner, since the surface of the printed circuit board facing away from the coils is typically almost flat in contrast to the axial end of the coil arrangement of the coils and thus hardly swirls the adjacent air.

Conveniently, the rotor can comprise a balancing disk which comprises the printed circuit board, wherein at least one ballast mass of the balancing disk is attached to the printed circuit board.

Current balancing disks, which are used to compensate for any imbalances, are typically fitted as an additional component at the axial end of the rotor, which requires additional installation space. A combination of the balancing disk with the printed circuit board, in which the printed circuit board serves as a carrier for the ballast mass of the balancing disk, offers the advantage that the balancing disk does not require any additional installation space. Furthermore, such a design can simplify the manufacturing process of the rotor and make it more cost-effective.

The ballast mass can advantageously have a density that is at least 3 times or at least 5 times or at least 10 times the density of the printed circuit board. The ballast mass can consist of a metal, for example, whereas the printed circuit board can be made of hard paper and/or epoxy resin and/or plastic.

The ballast mass can be designed as a ballast ring, which is arranged outside the printed circuit board in a radial direction in relation to the rotor shaft, for example, so that the ballast ring can surround the printed circuit board in the circumferential direction. Alternatively, the ballast ring may not surround the printed circuit board, but be connected to the printed circuit board at the radially outer edge, for example in the outer third, of the top side and/or bottom side of the printed circuit board, for example with a material bond. Accordingly, the respective ballast ring can be arranged on a side of the printed circuit board facing the coil or on a side facing away from the coil. In both cases, the ballast ring advantageously may comprise or cover a maximum of half of the printed circuit board in the radial direction.

Alternatively, it can be expedient to form the ballast mass as a plurality of individual ballast mass segments which can be arranged evenly spaced from one another in the circumferential direction, for example on the top side and/or bottom side of the printed circuit board. The ballast mass segments can advantageously be located in the outer third of the top side or the bottom side.

In a further development of the disclosure, the rotor can comprise a star disk which mechanically supports at least one component of at least one of the coils, wherein the star disk is electrically insulating and is arranged at an axial end, facing the printed circuit board, of a rotor body carrying the coils, wherein a winding of the respective coil is guided both around a respective tooth of the rotor body as well as around a respective section of the star disk.

The star disk can advantageously be designed in such a way that it supports the winding heads of the coils against the high centrifugal force during rotation. The star disk can be made of aluminum and in particular be a die-cast aluminum star disk. Aluminum forms a thin, natural oxide layer almost instantly on contact with oxygen, so that the star disc is protected against corrosion and is electrically insulating.

In conventional rotors, star disks can serve as a collection point for the wire ends of the coils that are to be connected to each other. Accordingly, such star disks often have a complex design due to the internal interconnection of wires, which can complicate the manufacturing process. In the rotor according to the disclosure, the interconnection of the respective wire ends of the coils is realized via the printed circuit board, so that no complex and expensive star disk is required. Instead, a simple and therefore less expensive star disk can be used for insulation purposes and to mechanically support at least one component of the coils.

The printed circuit board can be a multilayer board, so that at least one of the conductive sections of the printed circuit board connected to at least one of the wire ends is arranged at least in sections between two insulating layers of the printed circuit board.

As already discussed, the conductive sections that are connected to a respective wire end may advantageously be located at least partially on the side of the printed circuit board facing away from the coils. The use of a multilayer circuit board makes it possible in particular for different conductive sections that are insulated from each other within the circuit board and thus only indirectly connected to each other via at least one of the coils to overlap when viewed in the direction of the axis of rotation, as they can be guided on different layers, at least in the overlap region. This offers the advantage of simplified line routing with simultaneous robust insulation of the separate conductive sections from each other. Moreover, multilayer printed circuit boards can offer greater mechanical stability, which is an important aspect, particularly with regard to use for the rotor of an electric machine.

Furthermore, the disclosure relates to a separately excited electric machine with a stator, wherein the electric machine comprises a rotor according to the disclosure which is rotatably mounted on the stator. The separately excited electric machine can in particular be a separately excited synchronous machine.

In addition, the disclosure relates to a motor vehicle comprising at least one separately excited electric machine according to the disclosure.

Moreover, the disclosure relates to a manufacturing method for manufacturing a rotor for a separately excited electric machine, comprising the following steps:

providing of a printed circuit board having a first and a plurality of second through-holes and a rotor intermediate product, comprising a rotor shaft and a plurality of coils arranged in a stationary manner with respect to the rotor shaft, wherein each coil has two wire ends for making electrical contact with the coil,

guiding the rotor shaft through the first through-hole of the printed circuit board and displacing the printed circuit board along the rotor shaft so that the wire ends of each coil are guided

through a respective one of the second through-holes, so that at least a section of the respective wire end of each coil emerges on a side of the printed circuit board facing away from the coils, and

establishing a conductive connection between the wire ends of the respective coil and separate conductive sections of the circuit board.

First, the printed circuit board is applied to the rotor intermediate product and displaced along the rotor shaft so that the respective wire ends of the coils can be guided through the second through-holes in the printed circuit board. The wire ends of the respective coil are then interconnected or conductively connected to the separate conductive sections of the printed circuit board, for example with separate conductor tracks, in particular in such a way that the respective wire ends are mechanically fixed to the printed circuit board. The conductive connection can be made, for example, by soldering, i.e., in particular by way of soldering tin, by welding or by way of a conductive adhesive.

In a further development of the manufacturing method according to the disclosure, providing of the rotor intermediate product can further comprise the following steps: providing of a plurality of separate coils and a coil carrier, which is formed integrally with the rotor shaft or is attached to the rotor shaft in a rotationally fixed manner, and attaching the plurality of separate coils to the coil carrier in such a way that the wire ends of all coils protrude beyond the windings of the respective coil on the same side of the rotor intermediate product.

To manufacture the coils, a plurality of individual teeth or coil cores, which are ferromagnetic in particular, can be wrapped separately with wire. The coils produced in this way can then be attached to the coil carrier, e.g., placed on it or inserted into it, in such a way that the two wire ends of each coil protrude beyond the windings of the respective coil on the same side of the rotor intermediate product, i.e., at the axial end of the rotor intermediate product.

The coil carrier is, for example, a cylindrical element with a plurality of recesses in its outer wall in the circumferential direction for inserting said coils. Depending on the design of the rotor, the coil carrier can either be formed integrally with the rotor shaft or be formed separately from it and only fitted to the rotor shaft during the manufacturing process of the rotor. In order to prevent the individual coils from slipping out due to the centrifugal force acting when the rotor rotates, a support can be provided, which can be designed as a ring, for example, arranged around the coils in the circumferential direction.

Winding the teeth or coil cores separately and holding them on a coil carrier offers the advantage over winding teeth protruding from the rotor shaft by needle winding, for example, that the teeth or coil cores can be wound more tightly, as no groove has to be left between the individual coils for a winding needle. The groove between the side flanks of the coils can therefore be designed to be correspondingly narrow, wherein the groove can advantageously be a maximum of five times or a maximum of three times as wide as the wire diameter.

All features disclosed for the rotor according to the disclosure can also be transferred, along with the advantages mentioned, to the manufacturing process according to the disclosure and vice versa.

### BRIEF DESCRIPTION OF THE SEVERAL VIEWS OF THE DRAWINGS

Further advantages and details of the present disclosure can be seen from the exemplary embodiments described in the following as well as from the figures. The figures show schematically:

FIG. 1 is a schematic diagram of a motor vehicle according to the disclosure, comprising an exemplary embodiment of the electric machine according to the disclosure, which comprises an exemplary embodiment of the rotor according to the disclosure,

FIG. 2 is a schematic diagram of an exemplary embodiment of the rotor according to the disclosure,

FIG. 3 is an oblique view of a schematic diagram of a rotor intermediate product, which represents a preliminary stage in the manufacture of the rotor shown in FIG. 1, and

FIG. 4 is a flow chart of an exemplary embodiment of the manufacturing process according to the disclosure for the manufacture of a rotor.

### DETAILED DESCRIPTION

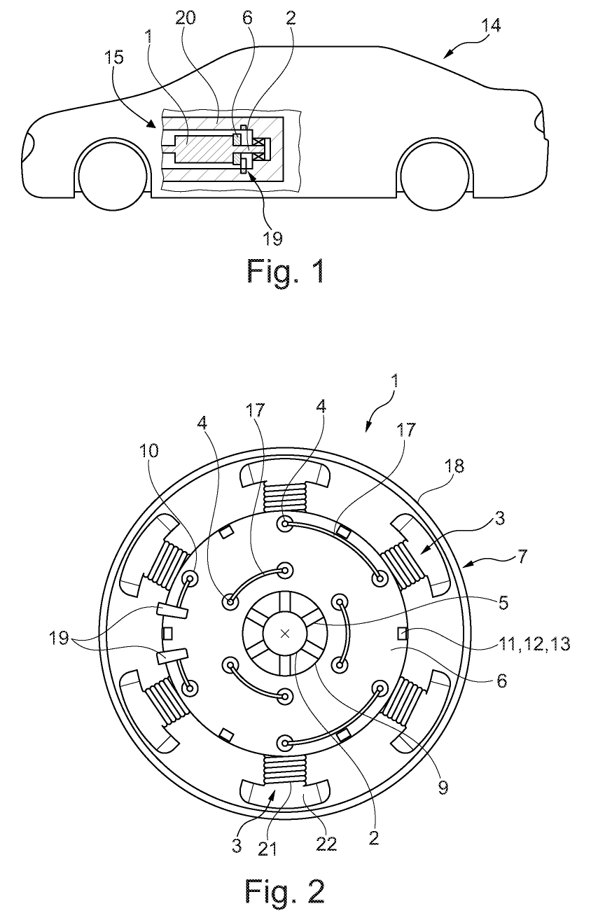

FIG. 1 shows a motor vehicle 14 with a separately excited electric machine 15. In the example, the electric machine 15 is a separately excited synchronous machine that can, for example, serve as a drive motor or one of the drive motors of the motor vehicle 14.

The rotor 1 is rotatably mounted on the stator 20 of the separately excited electric machine 15 via a rotor shaft 2 and comprises a plurality of coils 3, which in the example are used to generate a multi-pole stator field. Although the coils 3 are not shown in FIG. 1 for reasons of clarity, they are shown in the separate depiction of the rotor in FIG. 2. As will be explained in more detail below, the coils 3 are jointly contacted for energization with excitation current via a printed circuit board 6, which in the example connects the coils in series with one another between two sliding contacts 19, which serve to transmit the excitation current from the stator 20 to the rotor 1. The printed circuit board 6 has a first through-hole 9 through which the rotor shaft 2 is guided and extends essentially perpendicular to the axis of rotation 16 of the rotor.

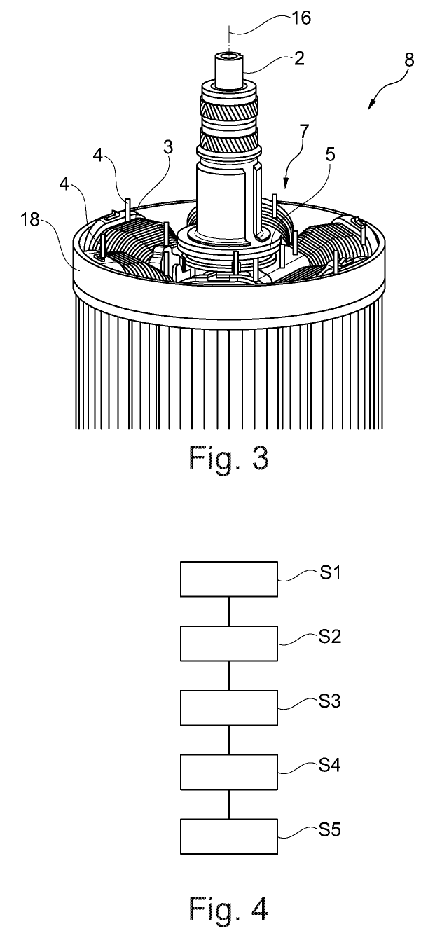

For contacting the coils with the printed circuit board 6, two wire ends 4 protrude from each coil 3, which extend essentially parallel to the axis of rotation 16 of the rotor 1 beyond the windings or the teeth or coil base body 22 of the respective coil 3 carrying the windings 21. This can be seen in particular in FIG. 3, which shows a perspective view of a rotor intermediate product 8 that is present in a manufacturing process for producing the rotor, which will be explained later, before the printed circuit board is attached. The wire ends 4 are guided through a respective second through-hole 10 of the printed circuit board 6 and thus protrude at least in sections from the second through-holes 10 of the printed circuit board 6 and thus extend to the side of the printed circuit board 6 facing the viewer in FIG. 2.

The second through-holes 10 are each only slightly larger than the diameter of the wire ends 10, so that they can be connected in a simple manner, for example by way of a solder connection, to a respective conductive section 17 of the printed circuit board 6 adjacent to the through-hole 10.

In this exemplary embodiment, the rotor 1 comprises a total of six coils 3 to form three pairs of magnetic poles. In alternative embodiments, the rotor 1 could of course also have more or fewer coils 3. In the example, as can be seen in FIG. 2 and 3, each coil 3 has a radially inner and a radially outer wire end. As all coils are wound in the same way in the example, a current flow through the coil from the respective radially inner wire end to the radially outer wire end results in a north pole and a reverse current flow results in a south pole of the rotor or vice versa.

To provide alternating magnetic poles in the circumferential direction of the rotor, in the series connection of the coils 3 shown in FIG. 2, adjacent coils 3 in the circumferential direction are therefore alternately connected to each other via their radially outer and radially inner wire ends 4 by the shown arrangement of the conductive sections 17 of the printed circuit board 6. Furthermore, the radially outer wire ends 4 of the two coils 3 shown on the left in FIG. 2 are connected to a respective sliding contact 19, for example to a wire brush for contacting a contact ring of the stator 20. Alternatively, a connection could be made to a rectifier for inductive energy transmission from the stator 20 to the rotor 1.

As an alternative to the series connection shown, the coils 3 could also be connected in parallel or partly in series and partly in parallel using a suitable design of the printed circuit board 6. It can be necessary or at least advantageous for conductive sections 17, which are at different potentials, to cross each other. This can be realized, for example, by using a multilayer board that has a plurality of layers and vias.

In the example shown in FIG. 2, the printed circuit board 6 covers approximately half of the coils 3 at one axial end 7 of a coil-carrying section of the rotor 1. It can be expedient if, contrary to the example shown, at least the windings 21 of the coils 3 are completely covered by the printed circuit board 6, so that the free wire ends 4 of the respective coil can be guided through the printed circuit board 3 without reshaping, even if they protrude from the radial ends of the respective winding 21.

In the example, the printed circuit board 6 is designed circular in shape, wherein the outer circumference of the printed circuit board 6 in the example shown is noticeably smaller than the outer circumference of the rotor 1 itself. This example was chosen, among other reasons, because in this case the windings 21 of the coils 3 remain partially visible, which makes the example easier to understand. This means that the printed circuit board 6 covers approximately half of the coils 3 in the example. Alternatively, the printed circuit board 6 could also be dimensioned in such a way that it covers the coils 3 to a greater extent or also, in particular, completely. As explained above, this can facilitate the contacting of the coils and also typically leads to reduced air friction when the rotor 1 rotates.

In the example, the coils 3 are designed as separate modules that are attached to a coil carrier 5. In addition, to prevent the individual coils 3 from slipping out due to the centrifugal force acting when the rotor 1 rotates, a support 18 is provided, which is designed as a ring and is placed around the coils 3 in the circumferential direction. This can be clearly seen in FIG. 2 in particular.

Furthermore, the printed circuit board 6 in the example forms part of a balancing disk 11, the ballast mass 12 of which is arranged as individual ballast mass segments 13 at regular intervals in the circumferential direction in a radially outer third of the upper side of the printed circuit board 6 facing away from the coils.

In particular, if the windings of all coils are wound on teeth of a common coil base body 22, contrary to the example explained above, the rotor 1 can additionally have a star disk, not shown, which is arranged between the coils 3 and the coil base body 22 carrying the coils 3. In this case, a winding 21 of the respective coil 3 is guided both around the respective tooth of the rotor body and around a respective section, in particular a prong, of the star disk, so that the star disk is firmly connected to both the rotor body and the coils and can thus contribute to the mechanical support of the windings.

Since the coils are contacted via the printed circuit board, which is separate from the star disk, a simple insulating star disk, for example made of aluminum, can be used.

FIG. 3 shows the rotor intermediate product 8 with the same elements already depicted in FIG. 2, with the exception of the printed circuit board 6.

In the exemplary embodiment shown, the coil carrier 5 is attached to the rotor shaft 2, i.e. it is not connected to it in one piece, although this would also be possible as an alternative. The coil carrier is cylindrical and has a slightly larger internal diameter than the diameter of the rotor shaft 2. Furthermore, on the side facing away from the rotor shaft 2, i.e. the outer wall of the coil carrier 5, the coil carrier 5 has a plurality of recesses in the circumferential direction into which the coils 3 can be inserted.

FIG. 4 shows a schematic flow chart for a manufacturing process for manufacturing the rotor 1 shown in FIG. 2.

In step S1, the coils 3 are manufactured first. To form the coils 3, individual teeth or coil base bodies 22 are wrapped with wire in such a way that for each coil 3 the two wire ends 4 of the wire protrude beyond the coil base body 22 of the respective coil 3. Each tooth is therefore wrapped with its own wire to form coil 3.

Then, in step S2, the coils 3 are placed on the coil carrier 5 or in its recesses.

In step S3, the coil carrier 5 is placed on the rotor shaft 2 and fixed to it in a rotationally fixed manner. Alternatively, the coil carrier 5 can already be connected to the rotor shaft 2 in one piece, so that this step can be omitted. On completion of step S3, the rotor intermediate product 8 shown in FIG. 3 is manufactured.

Then, in step S4, the rotor shaft 2 is inserted into the first through-hole 9 of the printed circuit board 6, after which the printed circuit board 6 is displaced along the rotor shaft until the printed circuit board meets the axial end 7 of the rotor intermediate product 8, in particular the coils 3. In doing so, the respective wire ends 4 of each coil 3 pass through the second through-holes 10 of the printed circuit board 6, whereby at least one section of each wire end 4 emerges on the side of the printed circuit board 6 facing away from the coils 3.

In a final step S5, a conductive connection is made, for example by soldering, between the respective wire end 4 and the respective conductive section 17 in order to interconnect these components.

German patent application no. 102025103126.6, filed January 29, 2025, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A rotor for a separately excited electric machine, having a plurality of coils for generating a rotor magnetic field, wherein each coil has two wire ends via which the respective coil is electrically contacted, the rotor comprising:
a printed circuit board which has a first through-hole and a plurality of second through-holes; and
a rotor shaft penetrating the first through-hole of the printed circuit board extending along an axis of rotation of the rotor,
wherein the wire ends of the coils are each guided through one of the second through-holes of the printed circuit board, so that at least one section of the respective wire end emerges from a side of the printed circuit board facing away from the coils and the wire ends of the respective coil are connected to separate conductive sections of the printed circuit board.

2. The rotor according to claim 1, wherein
at least one of the conductive sections of the printed circuit board conductively connects one of the wire ends of a first of the coils to one of the wire ends of a second of the coils, so that the first of the coils and the second of the coils are connected in series or parallel to one another by way of the printed circuit board.

3. The rotor according to claim 1, wherein
the printed circuit board is at least substantially circular and/or covers at least half of the plurality of coils in the radial direction with respect to the rotor shaft.

4. The rotor according to claim 1, wherein
the rotor comprises a balancing disk which comprises the printed circuit board, wherein at least one ballast mass of the balancing disk is attached to the printed circuit board.

5. The rotor according to claim 1, wherein
the rotor comprises a star disk which mechanically supports at least one component of at least one of the plurality of coils, wherein the star disk is electrically insulating and is arranged at an axial end, facing the printed circuit board, of a rotor body carrying the plurality of coils, and wherein a winding of the respective coil is guided both around a respective tooth of the rotor body as well as around a respective section of the star disk.

6. The rotor according to claim 1, wherein
the printed circuit board is a multilayer printed circuit board, so that at least one of the conductive sections of the printed circuit board connected to at least one of the wire ends is arranged at least in sections between two insulating layers of the printed circuit board.

7. A separately excited electric machine comprising:
a stator; and
a rotor according to claim 1, wherein the rotor is rotatably mounted on the stator.

8. A motor vehicle comprising at least one separately excited electric machine according to claim 7.

9. A manufacturing method for manufacturing a rotor for a separately excited electric machine, the method comprising:
providing of a printed circuit board having a first through-hole and a plurality of second through-holes and a rotor intermediate product, comprising a rotor shaft and a plurality of coils arranged in a stationary manner with respect to the rotor shaft, wherein each coil of the plurality of coils has two wire ends for making electrical contact with the coil;
guiding the rotor shaft through the first through-hole of the printed circuit board and displacing the printed circuit board along the rotor shaft so that the wire ends of each coil are guided through a respective one of the plurality of second through-holes, so that at least a section of the respective wire end of each coil emerges on a side of the printed circuit board facing away from the coils; and
establishing a conductive connection between the wire ends of the respective coil and separate conductive sections of the printed circuit board.

10. The manufacturing method according to claim 9,
wherein providing the rotor intermediate product comprises:
providing of a plurality of separate coils and a coil carrier, which is formed integrally with the rotor shaft or is attached to the rotor shaft in a rotationally fixed manner, and
attaching the plurality of separate coils to the coil carrier in such a way that the wire ends of the plurality of coils protrude beyond the windings of the respective coil on the same side of the rotor intermediate product.
